(19) United States
(12) Patent Application Publication
(10) Pub. No.: US 2005/0069379 A1
(43) Pub. Date: Mar. 31, 2005

(54) Stopping means

(76) Inventor: Reinhard Smetz, Baldingen (DE)

Correspondence Address: Mark P Stone, 4th Floor, 25 Third Street, Stamford, CT, 06905, US

(21) Appl. No.: 10/498,869

(22) PCT Filed: Dec. 18, 2002
(86) PCT No.: PCT/DE02/04692

(30) Foreign Application Priority Data
Dec. 21, 2001 (DE) 101 64 596.1

(51) Int. Cl. F16G 15/08

(52) U.S. Cl. 403/164

(57) ABSTRACT

Disclosed is a stopping means for carrying or lashing means, provided with a fork head. An eye (8) is disposed next to the insertion slot (7) of the fork head, whose inside width (W₂) is larger than the inside width (W₁) of the insertion slot (7).

### TECHNICAL FIELD

The invention relates to a stopping means which serves to connect an object to a carrying or lashing means and has a fastening member, which is to be fastened to the object and an attachment member, which is mounted in a manner such that it can rotate relative to the fastening member and has a fork head, the fork prongs of which bound at their ends an insertion gap which can be closed by a cross-bolt.

### PRIOR ART

A stopping means of the abovementioned type which is also referred to in practice as a stopping point is disclosed in FIG. 10 of EP 0462963 B1. The fork head of the attachment member of this stopping means has—as generally customary—two parallel fork prongs whose length and whose distance from each other are of a size sufficient in order to be able to fit the end link of a chain strand or chain strand section into the U-shaped insertion gap bounded by the fork prongs and to be able to secure it there with the aid of a cross-bolt. The known construction is not able to be completely satisfactory insofar as, firstly, its insertion gaps or slot widths which are comparatively large in relation to the thickness of the end link of the chain strand to be attached result in unfavorable loadings of the cross-bolt and because, secondly, the attachment of components which are matched to the gap or slot width and have flattened zones, such as suspension links or eye hooks, is impossible.

### SUMMARY OF THE INVENTION

The invention is based on the object of providing a stopping means of the type under consideration to which, in contrast with known, relevant stopping means, not only end links of chain strand sections can be attached. According to the invention, this object is achieved in the case of a stopping means of the type under consideration by the fact that the insertion gap of the attachment member is adjoined by an eye, the inside width of which is larger than the inside width of the insertion gap.

The stopping means according to the invention affords the advantage that it permits the direct attachment of hooks, shortening claws, attachment and suspension links, having flattened sections in a known manner in their attachment regions, to the fork head of the attachment member, the mobility of the parts which are fitted into the eye of the fork head being significantly increased in comparison to the mobility of a chain link which is held by the cross-bolt in the insertion gap of the known fork heads. Added to this is the fact that, in the cases in which carrying or lashing means act at an angle on the particular object, the transmission of force no longer absolutely has to take place via the cross-bolt, but rather, in order to transmit force, use can be made of the fork prongs which generally have a much larger cross section than the particular cross-bolt, and this affords the further advantage that the point of application of the force moves closer to the object to be lashed or lifted.

Further features and details of the invention emerge from the subclaims and the description below of a number of exemplary embodiments of the invention which are illustrated in the attached drawings.

### BRIEF DESCRIPTION OF THE DRAWINGS

In the drawings:

FIG. 1 shows, partially in section, the front view of a first stopping means;

FIG. 2 shows the side view of the stopping means according to FIG. 1;

FIG. 3 shows, partially in section, the plan view of the stopping means according to FIGS. 1 and 2;

FIG. 4 shows the side view of a modified stopping means;

FIG. 5 shows, partially in section, the front view of the stopping means according to FIG. 4;

FIG. 6 shows a partial section along the line VI-VI in FIG. 4;

FIG. 7 shows the side view of a third stopping means;

FIG. 8 shows, partially in section, the front view of the stopping means according to FIG. 7;

FIG. 9 shows a plan view of the stopping means according to FIGS. 7 and 8, and

FIG. 10 shows an overview of the various components which can be attached to the stopping means according to FIGS. 1 to 9 and can be connected to them to form a unit.

### WAYS OF IMPLEMENTING THE INVENTION

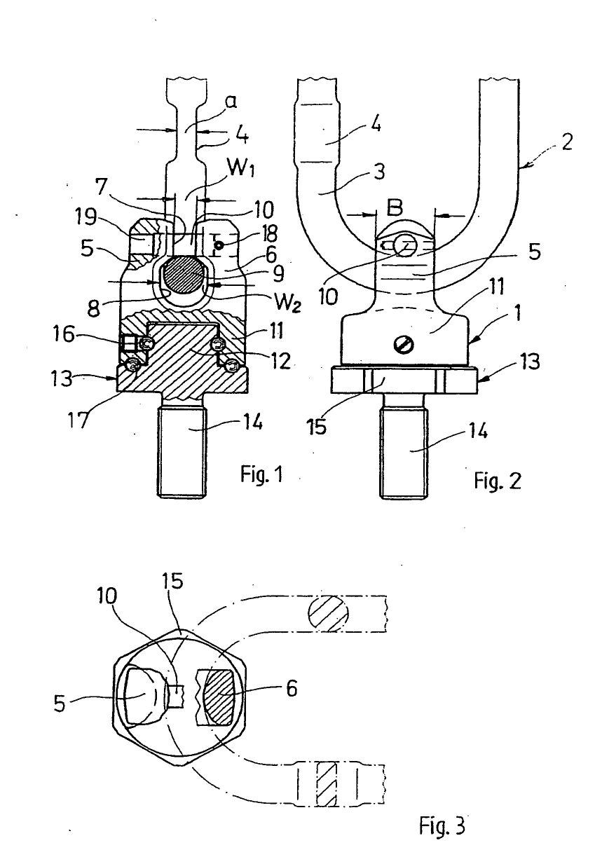

In FIG. 1, 1 is the attachment member of a stopping means, into which an oval suspension link 2 of round steel is fitted. In the region of its longitudinal limb 3, the suspension link 2 has a flattened zone 4, the thickness a of which is smaller than the width W₁ of an insertion gap 7 of the attachment member 1, which gap is bounded by the fork prongs 5 and 6 of a fork head. The inner width bᵢ of the suspension link 2 is of a size sufficient in order to be able to receive a hook arranged at the end of a lashing or carrying means formed by a chain strand, a strap or a cable. In order to permit the direct attachment of the suspension link 2 to the attachment member 1, the insertion gap 7 merges into an essentially annular eye 8, the inside width W₂ of which is at least equal to 1.5 times the inside width W₁ of the insertion gap 7 and which provides sufficient space for the circular cross section 9 of the curve of the suspension link 2. In respect of their dimensions and shape, the fork prongs 5 and 6 are designed in such a manner that the attachment link 2 can be supported, depending on its position, either—as shown in FIGS. 1 and 2—on a cross-bolt 10 spanning the insertion gap 7 or else—as indicated in FIG. 3—on one of the fork prongs 5 or 6. Owing to the fact that those sides of the prongs 5 and 6 which face each other in the region of the eye 8 are rounded—as can be seen with reference to the prong 6 in FIG. 3—notch stresses caused by edges are avoided.

The fork prongs 5 and 6 are formed by projections of a cap-shaped base 11 of the attachment member 1, which base engages around a pin 12 of a fastening member 13 which is provided with an integral threaded bolt 14. Situated between the pin 12 and the threaded bolt 14 is an annular collar 15, the circumferential surface of which, as can best be seen from FIG. 3, is in the shape of a hexagon which permits the introduction of a rotational movement into the fastening member 13. In order to obtain high rotatability of the attachment member 1 relative to the fastening member 13, use is made of two rows of rolling bodies 16, 17 which form deep groove ball bearings and of which the row of rolling bodies 16 at the same time ensures that the attachment member 1 and the fastening member 13 are held together.

It has turned out to be particularly advantageous to design the connection between the attachment member 1 and the suspension link 2 in such a manner that the abovementioned parts cannot readily be separated from each other, but rather form a unit. In the case illustrated, the cross-bolt 10 is therefore mounted in a stepped hole 19 secured by means of a clamping sleeve 18.

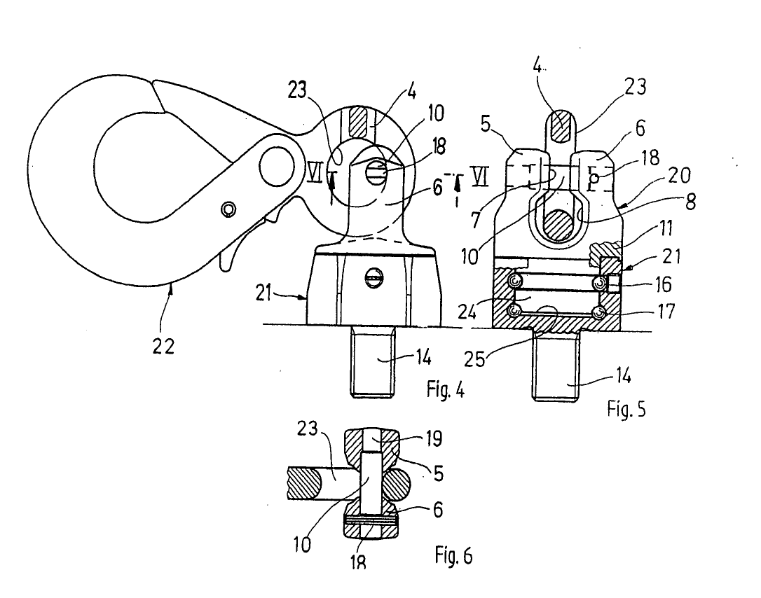

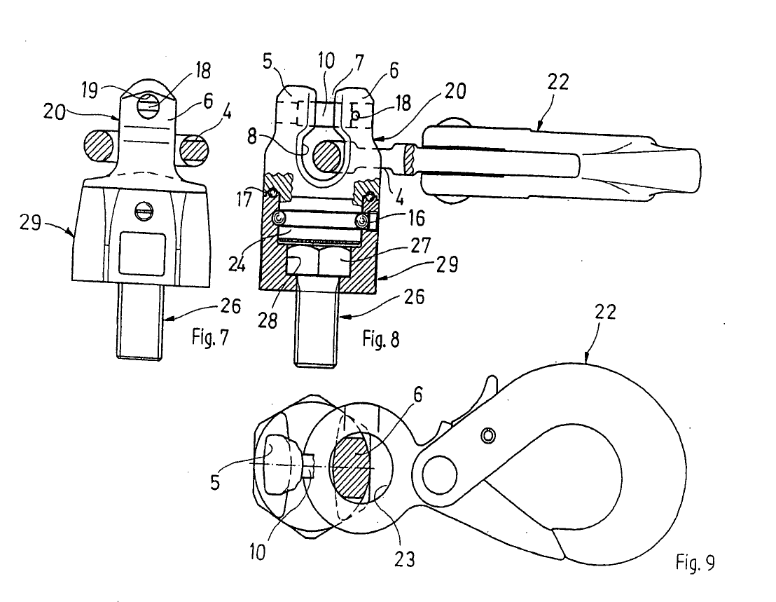

FIGS. 4 to 6 illustrate a stopping means having a modified attachment member 20 and a likewise modified fastening member 21, with the same reference numbers in FIGS. 1 to 3 being used for mutually corresponding parts. In this second embodiment too, a further component in the form of an eye hook 22 is connected to the fork head of the attachment member 20, which head has fork prongs 5 and 6, to form a captive unit. Like the suspension link 2 of the previously described construction, the hook eye 23 of the eye hook 22 has a flattened zone 4 which permits the direct connection between the eye hook 22 and the attachment member 20. Unlike in the embodiment according to FIGS. 1 to 3, the base 11 of the attachment member 20, which base supports the fork prongs 5 and 6 and is not of cap-shaped design here, but rather of disk-shaped design, is adjoined by a guide pin 24 which is supported via two rows of rolling bodies 16, 17 in the interior of a cylindrical recess 25 of the fastening member 21 which is provided in turn with an integral threaded bolt 14.

Whereas the previously described stopping means have fastening members 13 and 21 with integral threaded bolts 14, FIGS. 7 to 9 illustrate a construction in which the fastening member 26 is formed by a standard threaded bolt, the hexagon head 27 of which rests in a recess 28, which surrounds it in a form-fitting manner, of a connecting member 29, the outer contour of which is designed, like the outer contour of the fastening member 21, as a hexagon. In order to reduce the height of the pin 24 and to increase the strength of the attachment member 20 against tilting in comparison with the connecting member 29, an arrangement of the row of rolling bodies 16, 17 similar to the one in the embodiment according to FIGS. 1 to 3 has been selected, i.e. the deep groove ball bearing formed by the row of rolling bodies 16 has been designed as a radial bearing and the deep groove ball bearing formed by the row of rolling bodies 17 has been designed as an axial bearing.

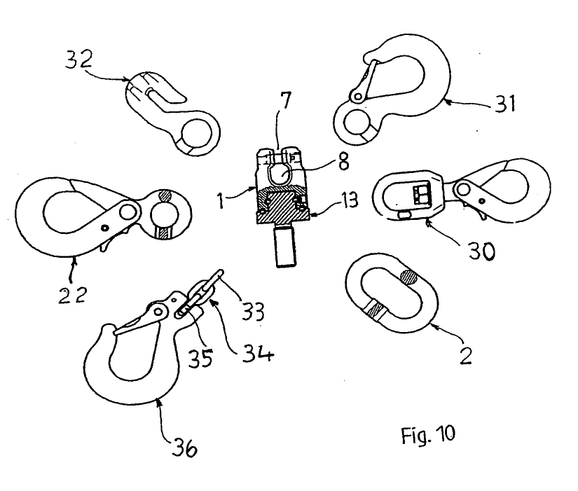

FIG. 10 shows diverse possibilities of a combination of the stopping means according to FIGS. 1 to 3 with different components. It is thus possible to fit, apart from the suspension link 2 and the eye hook 22, an angle hook 30, a modified eye hook 31, a shortening element 32, but also the one end link 33 of a short chain strand section 34, the other end link 35 of which is connected to a hook 36 which is provided with a fork head according to the prior art. It goes without saying that the parts 30, 31 and 32 also have to have flattened portions in the coupling region, which permit the insertion of said parts into the insertion gap 7 of the fork head designed in accordance with the invention.

1. A stopping means which serves to connect an object to a carrying or lashing means and has a fastening member (13), which is to be fastened to the object and is secured against relative movements with respect to the object, and an attachment member (1), which is mounted in a manner such that it can rotate relative to the fastening member (13) and has a fork head, the fork prongs (5, 6) of which bound at their ends an insertion gap (7) which can be closed by a cross-bolt (10), characterized in that the insertion gap (7) of the attachment member is adjoined by an essentailly annular eye (8), the inside width (W₂) of which is larger than the inside width (W₁) of the insertion gap (7), which width is matched to flattened zones of components (2; 22; 30; 31; 32) that can be inserted into the fork head.

2. The stopping means as claimed in claim 1, characterized in that the inside width (W₂) of the eye (8) is at least equal to 1.5 times the inside width (W₁) of the insertion gap (7).

3. The stopping means as claimed in claim 2, characterized in that the inside width (W₂) of the eye (8) is equal to the 1.8 to 2.2 times the inside width (W₁) of the insertion gap (7).

4. The stopping means as claimed in claim 1, characterized in that the width (B) of the fork prongs (5, 6) in the region of the eye (8) is equal to 2.5 to 3.5 times the width (W₁) of the insertion gap (7).

5. The stopping means as claimed in claim 1, characterized in that those sides of the fork prongs (5, 6) which face each other in the region of the eye (8) are rounded.

6. The stopping means as claimed in claim 1, characterized in that the fork prongs (5, 6) are formed by projections of a cap-shaped base (11) of the attachment member (1), and in that the base (11) at least partially engages over the fastening member (13).

7. The stopping means as claimed in claim 6, characterized in that the base (11) of the attachment member (1) is supported on the fastening member (13) via rolling bearings (16, 17).

8. The stopping means as claimed in claim 7, characterized in that the fastening member (13) has a pin (12) which projects into the cap-shaped base (11) of the attachment member (1) and an annular collar (15) adjoining the pin (12).

9. The stopping means as claimed in claim 8, characterized in that a first row of rolling bodies (16) is arranged between the inside wall of the cap-like base (11) of the attachment member (1) and the pin (12) of the fastening member (13), and a second row of rolling bodies is arranged between the end surface of the cap-shaped base (11) of the attachment member (1) and the annular collar (15) adjoining the pin (12) of the fastening member (13).

10. The stopping means as claimed in claim 8, characterized in that the circumferential surface of the annular collar (15) adjoining the pin (12) of the fastening member (13) is designed as a hexagon.

11. The stopping means as claimed in claim 1, characterized in that the fork prongs (5, 6) are formed by projections of a disk-shaped base (11) of the attachment member (20), which base has, on its side facing away from the eye (8), a guide pin (24) mounted in a recess (25) of the fastening member (21).

12. The stopping means as claimed in claim 11, characterized in that the attachment member (1; 20) is supported on the fastening member (13; 21) via rolling bearings (16, 17).

13. The stopping means as claimed in claim 12, characterized in that the supporting takes place via two rows of rolling bodies (16, 17).

14. The stopping means as claimed in claim 13, characterized in that the two rows of rolling bodies (16, 17) are arranged in the region of the recess (25) for the guide pin (24).

15. The stopping means as claimed in claim 9, characterized in that at least one row of rolling bodies (16) forms a deep groove ball bearing ensuring that the attachment member (1; 20) and the fastening member (13; 21) are held together.

16. The stopping means as claimed in claim 1, characterized in that the attachment member (20) is connected to the fastening member (26) via a connecting member (29).

17. The stopping means as claimed in claim 16, characterized in that the attachment member (20) is supported on the connecting member (29) via rolling bearings (16, 17).

18. The stopping means as claimed in claim 17, characterized in that the supporting takes place via two rows of rolling bodies (16, 17).

19. The stopping means as claimed in claim 18, characterized in that the two rows of rolling bodies (16, 17) are designed as deep groove ball bearings.

20. The stopping means as claimed in claim 1, characterized in that it is connected to a hook (22) to form a captive unit.

21. The stopping means as claimed in claim 1, characterized in that it is connected to a suspension link (2) to form a captive unit.

22. The stopping means as claimed in claim 20, characterized in that, in order to safeguard the captive nature of the components (2; 22) connected to the attachment member (1; 20) in each case to form a unit, the cross-bolt (10) which spans the insertion gap (7) is arranged in a stepped hole (19) which is locked by means of a clamping sleeve (18).

23. The stopping means as claimed in claim 9, characterized in that the circumferential surface of the annular collar (15) adjoining the pin (12) of the fastening member (13) is designed as a hexagon.

24. The stopping means as claimed in claim 12, characterized in that at least one row of rolling bodies (16) forms a deep groove ball bearing ensuring that the attachment member (1; 20) and the fastening member (13; 210 are held together.

25. The stopping means as claimed in claim 21, characterized in that, in order to safeguard the captive nature of the components (2; 22) connected to the attachment member (1; 20) in each case to form a unit, the cross-bolt (10) which spans the insertion gap (7) is arranged in a stepped hole (19) which is locked by means of a clamping sleeve (18).
